(19) United States
(12) Patent Application Publication
(10) Pub. No.: US 2014/0351152 A1
(43) Pub. Date: Nov. 27, 2014

(54) Method And System For Service Of Process

(71) Applicant: Philip Geron, Union, NJ (US)

(72) Inventor: Philip Geron, Union, NJ (US)

(21) Appl. No.: 13/974,247

(22) Filed: Aug. 23, 2013

Related U.S. Application Data
(60) Provisional application No. 61/855,738, filed on May 23, 2013.

(51) Int. Cl. G06Q 50/18; G06Q 30/00

(52) U.S. Cl. CPC G06Q 50/18; G06Q 30/00
USPC 705/311

(57) ABSTRACT

Methods and systems for service of process by which a client is automatically brought into contact with a process server authorized to serve process in a geographical jurisdiction in which process is to be served. The client communicates with a central processing station by telephone, internet or computer, and inputs into central processing station the telephone area code or the postal zip code corresponding to the geographical jurisdiction in which process is to be served. Process servers authorized to serve process in different geographical jurisdictions are registered in a database of the central processing station. The client, upon accessing the central processing station, enters either the telephone area code or the postal zip code corresponding to the geographical jurisdiction in which process is to be served. The central processing system then automatically places the client in contact, by telephone, internet or computer, with a process server registered in the database who is authorized to serve process in the geographical jurisdiction corresponding to the telephone area code or postal zip code designated by the client.

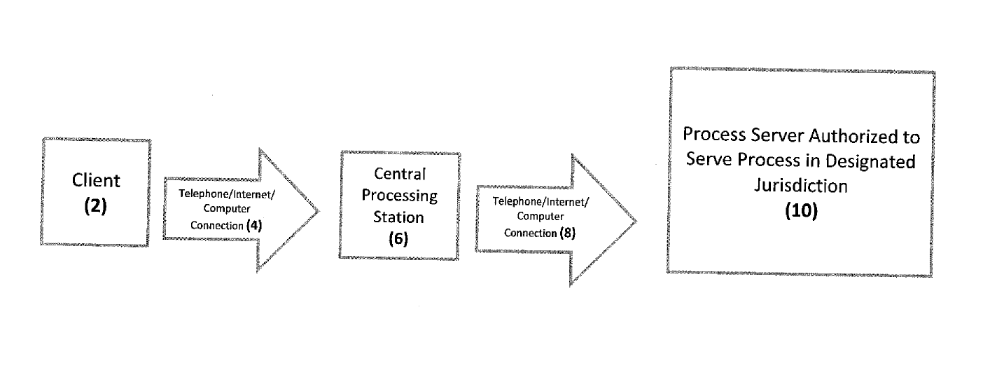

The present patent application claims the benefit of U.S. Provisional Patent Application Ser. No. 61/855,738 filed on May 23, 2013, pursuant to 35 U.S.C. 119 (e).

### BACKGROUND OF THE INVENTION

The present patent application is directed to an improved method for obtaining a process server and serving process, including legal process, in a designated geographical area.

Currently a person in need of service of process contacts a local process server to effect service. If service of process is to be made outside the jurisdiction of the contacted process server, it is necessary for the first process server to locate another process server authorized to serve process in the desired jurisdiction. This procedure involves multiple contacts, thereby increasing the cost of effecting service of process.

In the alternative, a person seeking a process server in a remote geographical jurisdiction is required, on his own, to locate such process server and make direct contact with the process server.

It is the primary object of the present invention to provide a method and system by which an individual seeking service of process in any geographical jurisdiction within the United States automatically and directly contacts a process server in the desired geographical jurisdiction.

### SUMMARY OF THE INVENTION

In accordance with the present invention, a central process serving organization retains subscribing process servers authorized to serve process, including legal process, in specific geographical jurisdictions within the United States designated by either the telephone area code corresponding to the designated geographical jurisdiction or the postal zip code corresponding to the designated geographical jurisdiction. A client in need of service of process in a remote jurisdiction contacts, by either telephone or computer/internet, a central telephone station or internet website of the process serving organization. The process serving organization retains subscribing process servers authorized to serve process in different geographical jurisdictions within the United States. Each subscriber is registered with the central telephone station/website of the process serving organization for a single geographical area corresponding to the telephone area code or the postal zip code for the geographical jurisdiction in which the subscriber is authorized to serve process. Each subscriber pays a predetermined fee to the process serving organization, and each subscriber has exclusive rights to serve process for the process serving organization within the designated geographical jurisdiction.

When the client contacts the central telephone station/website of the processing serving organization, the client enters the telephone area code or the postal zip code in which service of process is desired. The central telephone station/website then automatically connects the client, by telephone or internet, to the subscribing process server in the geographical jurisdiction corresponding to the telephone area code or postal zip code designated by the client.

The method and system provided by the present invention enables persons in need of service of process in any geographical jurisdiction within the United States to conveniently, efficiently, and automatically contact a process server authorized to serve process in the designated geographical jurisdiction without the need to contact multiple process serving agencies, or locate process servers in remote geographical jurisdictions on their own.

### BRIEF DESCRIPTION OF THE DRAWINGS

The single drawing FIGURE is a flow chart illustrating the system and method in accordance with the present invention for service of process in a designated geographical jurisdiction.

### DETAILED DESCRIPTION OF THE BEST MODES FOR CARRYING OUT THE INVENTION

In accordance with the present invention, a method and system are provided to enable a person in need of service of process, including legal process, in any geographical jurisdiction within the United States to quickly, directly and automatically contact a process server authorized to serve process in the desired geographical jurisdiction.

Referring to the single drawing FIGURE, a person or business designated by reference numeral 2 (hereinafter referred to as the “client”) located, for example, in New York, requires service of process in a remote jurisdiction, as for example, California. The client 2 contacts, by telephone/internet/computer designated by reference numeral 4, a central automated telephone processing station/website designated by reference numeral 6 operated by a process service organization.

The process service organization retains a plurality of subscribing process servers in numerous geographical jurisdictions throughout the United States. The geographical jurisdiction of each separate subscribing process server is designated by either the telephone area code or the postal zip code in which the process server is authorized to serve process. Preferably, the subscribing process servers cover all geographical jurisdictions of the United States, and each subscribing process server is authorized by the process serving organization as the exclusive process server for service of process in the designated geographical jurisdiction. The individual subscribers pay a subscription fee to the process serving organization for exclusive rights to their designated geographical jurisdiction.

Once the client 2 has contacted the central automated telephone processing station/website 6 of the process serving organization, the client enters either the telephone area code or the postal zip code of the geographical area in which process is to be served. The central automatic telephone processing station/website 6 of the process service organization automatically and directly places the client 2 in contact through telephone/internet/computer 8 with the subscribing process server 10 who is authorized to serve process in the desired geographical jurisdiction designated by the telephone area code or postal zip code entered into the central station 6 by the client 2.

The system and method described above can be readily implemented by use of known automated telephone processing systems, and known internet processing systems utilizing known general purpose computers and central processing stations.

The method and system of the present invention enables a client in any geographical jurisdiction within the United States to directly, automatically, and quickly locate a process server authorized to serve process in any geographical jurisdiction within the United States.

Other advantages of the present invention will become apparent to those skilled in the relevant art. Accordingly, the description of the invention method and system of the present made herein is intended to be illustrative only, and not restrictive of the scope of the invention, that scope being defined by the following claims and all equivalents thereto.

1. A method by which a client locates a process server in a designated geographical jurisdiction, the steps of said method comprising:
communicating by said client with a central processing station, said central processing station having a database identifying process servers authorized to serve process in different geographical jurisdictions;
inputting by said client into said central processing station a telephone area code or a postal zip code corresponding to a geographical jurisdiction in which process is to be served; and
automatically placing the client in contact, through said central processing station, with a subscribing process server authorized to serve process in the geographical jurisdiction corresponding to the telephone area code or postal zip code inputted by the client.

2. The method as claimed in claim 1, wherein said database includes only a single subscribing process server for a geographical jurisdiction corresponding to a single telephone area code or a single postal zip code.

3. The method as claimed in claim 1, wherein said client communicates with said central processing station by telephone, computer, or internet.

4. The method as claimed in claim 1, wherein said client is automatically placed in contact with said subscribing process server by telephone, computer or internet.

5. A system for locating a process server for service of process in a designated geographical jurisdiction, said system comprising:
a central processing station accessible to a client desiring service of process in a designated geographical jurisdiction;
said central processing station having a database identifying authorized subscribing process servers in different geographical jurisdictions designated by the telephone area code or the postal zip code corresponding to the different geographical jurisdictions; and
a communication system for placing the client in contact, through said central processing station, with a subscribing process server in a geographical jurisdiction corresponding to a telephone area code or postal zip code designated by the client into said central processing station.

6. The system as claimed in claim 5, wherein the database identifies only a single subscribing process server corresponding to a geographical jurisdiction designated by a single telephone area code or a single postal zip code.

7. The system as claimed in claim 5, wherein said central processing station is accessible to the client by telephone, computer, or internet.

8. The system as claimed in claim 5, wherein said communication system places the client in contact with the process server by telephone, computer or internet.
